(19) United States
(12) Patent Application Publication
(10) Pub. No.: US 2021/0340025 A1
(43) Pub. Date: Nov. 4, 2021

(54) Compositions and Methods for Purification of Metals from Steel Making Waste Streams

(71) Applicant: Lixivia, Inc., Santa Barbara, CA (US)

(72) Inventor: Michael D. Wyrsta, Santa Barbara, CA (US)

(21) Appl. No.: 17/283,402

(22) PCT Filed: Oct. 10, 2018
(86) PCT No.: PCT/US2018/055270

§ 371 Date: Apr. 7, 2021

(51) Int. Cl. C01G 49/02; C21B 3/06; C21B 5/04; C22B 26/20; C22B 7/04

(52) U.S. Cl. CPC C01G 49/02; C21B 3/06; C22B 7/04; C22B 26/20; C21B 5/04

(57) ABSTRACT

Systems and methods are described in which spent pickle liquor from metal cleaning processes is utilized to regenerate a lixiviant used to recover valuable metals from industrial waste and other sources. The spent pickle liquor is neutralized and solvated metals in the spent pickle liquor are precipitated in this process. When the industrial waste is slag from a metal refining process a partially closed metal production process can be implemented, where spent pickle liquor from cleaning of the refined metal is used to regenerate a lixiviant used to recover a different, valuable metal from a waste slag of the process, with precipitated salts from the lixiviant regeneration being returned as a raw material in the metal refining process. As a result waste streams from these processes are dramatically reduced or eliminated.

### FIELD OF THE INVENTION

The field of the invention is treatment or use of waste streams from metal processing.

### BACKGROUND

The following description includes information that may be useful in understanding the present invention. It is not an admission that any of the information provided herein is prior art or relevant to the presently claimed invention, or that any publication specifically or implicitly referenced is prior art.

Steel production and processing generates large volumes of waste products. One of the major waste streams is slag, in its various forms (BOF, LMF, Desulph, Dephos, etc.). Approximately 300 kgs of steel slag are produced for every ton of raw steel made. Another waste product of steel processing is a result of pickling, a process of involving chemical dissolution of surface impurities from the steel. Pickling is performed using a variety of acidic preparations, all of which form soluble salts with the components of surface impurities commonly found on steel (such as iron oxide). Typical pickling compositions include hydrochloric acid, nitric acid, sulfuric acid, and some organic acids. The resulting spent pickle liquors are often considered toxic or hazardous. The scale of spent pickle liquor production is considerable, with China alone producing in excess of 10⁶ cubic meters of spent pickle liquor annually.

Currently the most common method for treatment of spent pickle liquors is simple neutralization, typically with lime, followed by disposal. Unfortunately this disposal is often into local bodies of water, where it introduces considerable metal contamination. U.S. Pat. No. 2,746,920 (to Wunderley) describes the use of blast furnace slag to neutralize spent pickle liquor, however large amounts of slag are required. All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Jianzhao Tang et al. (Procedia Environmental Sciences 31:778-784 (2016)) discusses a process in which iron is recovered from spent pickle liquor from steel making processes by adding ammonia or ammonium salts to generate Fe(OH)₂, from which iron oxide can be generated by calcination and recovered as a source of iron. Ammonia, however, is volatile and the large amounts of ammonia utilized would require implementation of environmental controls.

Thus, there is still a need for a safe, economical, and environmentally conscious method for treating waste products of metal processing.

### SUMMARY OF THE INVENTION

The inventive subject matter provides apparatus, systems and methods in which spent pickle liquor from metal processing is used to regenerate a spent lixiviant, which can be obtained from processing industrial waste materials for recovery of commercially valuable metals. In some embodiments the spent lixiviant is a product of treatment of waste (such as steel slag) from the metal producing process that generates the spent pickle liquor, providing for an at least partially closed metal production process.

One embodiment of the inventive process is a method for processing a spent pickle liquor, by obtaining an industrial waste that includes CaO or Ca(OH)₂, and contacting the industrial waste with a lixiviant to solvate calcium from the industrial waste as a water soluble calcium salt. This generates a calcium-depleted industrial waste and a spent lixiviant. The spent lixiviant with the spent pickle liquor, which includes a water soluble salt of a metal (such as iron, copper, aluminum, cobalt, magnesium, barium, strontium, gold, and/or silver), to produce a suspension that includes a regenerated lixiviant and an insoluble salt of the metal. The water soluble salt of the metal can include a counterion (for example, a halide, an organic anion, nitrite, or nitrate) that is selected to provide a water soluble calcium salt when complexed with calcium. The spent pickle liquor can be a waste product of steel production, in which case the metal is iron. The method can also include a further step of separating the insoluble salt of the metal from the regenerated lixiviant, which permits recycling of the regenerated lixiviant to use in treatment of additional industrial waste. In some embodiments the method includes a step of recovering calcium from the water soluble calcium salt by contacting the water soluble calcium salt with a precipitant. Some embodiments of the inventive concept include the step of combining the depleted industrial waste and the insoluble salt of the metal to generate a calcium depleted filler, which can be incorporated into a building material. In methods where the metal is iron the insoluble salt of the metal can be supplied to a steel production process.

Another embodiment of the inventive concept is an integrated steel making process, which includes contacting an iron containing raw material with coke and lime, followed by heating to produce pig iron, contacting pig iron with oxygen to produce a mixture of steel and a steel slag, separating the mixture of steel and steel slag to provide a steel and a steel slag, treating the steel slag with a lixiviant selected to solubilize a metal from the steel slag to produce a mixture of depleted slag, extracted metal (for example, calcium), and spent lixiviant, treating the steel with a pickling solution to generate a cleaned steel and a spent pickling solution that includes iron, separating the extracted metal from the mixture to generate a second mixture that includes the depleted slag and spent lixiviant, contacting the second mixture with the spent pickling solution to generate an iron-enriched slag and a regenerated lixiviant, and returning the regenerated lixiviant to the slag extraction process. The lixiviant can be provided in substoichiometric amounts relative to the amount of metal in the steel slag. The iron-enriched slag can be returned to the integrated steel making process as a raw material, or can be utilized in a building material. In some embodiments the spent pickling solution is added as a series of aliquots.

Another embodiment of the inventive concept is an integrated steel making process, which includes contacting an iron containing raw material with coke and lime, followed by heating to produce pig iron, contacting pig iron with oxygen to produce a mixture of steel and a steel slag, separating the mixture of steel and steel slag to provide a steel and a steel slag, treating the steel slag with a lixiviant selected to solubilize a metal (such as calcium) from the steel slag to produce a mixture of depleted slag, extracted metal, and spent lixiviant, treating the steel with a pickling solution to generate a cleaned steel and a spent pickling solution that includes iron, separating the extracted metal to generate a second mixture that includes the depleted slag and spent lixiviant, separating the second mixture to generate a depleted slag stream and a spent lixiviant stream, mixing the spent lixiviant with the spent pickling solution to generate a regenerated lixiviant, and returning at least a portion of the regenerated lixiviant to the slag extraction process. In some embodiments iron salts precipitated during lixiviant regeneration are returned to the integrated steel making process as a raw material. The depleted slag can be utilized in a building material. The lixiviant can be used in substoichiometric amounts relative to the content of the metal in the steel slag.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 schematically depicts a method for utilizing spent pickle liquor in extracting calcium from steel slag using a single reactor.

FIG. 2 schematically depicts a method for utilizing spent pickle liquor in extracting calcium from steel slag using two reactors, with segregation of calcium extraction and lixiviant regeneration steps.

FIG. 3 depicts typical results of a pH vs time study for extraction of calcium from steel slag extraction using spent pickle liquor and a monoethanolamine-HCl (MEACl) lixiviant.

FIG. 4 depicts typical results of a pH vs time study for extraction of calcium from steel slag extraction using spent pickle liquor and a lysine⋅HCl lixiviant.

FIG. 5 depicts typical results of a pH vs time study for extraction of calcium from steel slag extraction using spent pickle liquor and a monoethanolamine-HCl (MEACl) lixiviant in a two-step process.

FIG. 6 schematically depicts a prior art steel making process.

FIG. 7 schematically depicts an integrated steel making process of the inventive concept, where waste streams are utilized as sources of commercially valuable materials and recycled back into the steel making process.

FIG. 8 schematically depicts an alternative integrated steel making process of the inventive concept, where waste streams are utilized as sources of commercially valuable materials and recycled back into the steel making process.

### DETAILED DESCRIPTION

Compositions and methods of the inventive concept provide processes for utilizing multiple waste products of the steel making process as active components useful in certain steps within the steel making process, thereby recycling and re-using at least a portion of these raw materials. Specifically, spent pickle liquor can be utilized to regenerate a lixiviant that is selective for extracting and (subsequently recovering) calcium and/or other commercially valuable metals from various forms of steel slag. In some embodiments spent pickle liquor can be so applied to regeneration of lixiviant utilized to recover commercially valuable metals (such as calcium) from a variety of waste minerals and/or industrial waste products that are not directly linked to steel production, such as cement kiln dust, fly ash, waste municipal ash, lime fines, electronic waste, etc.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

In some embodiments spent pickle liquor can be used to extract calcium and/or other valuable metals from steel slag via an exchange reaction between metal salts (e.g. ferric chloride) of the spent pickle liquor and lixiviant species. This results in precipitation of the metal components of such metal salts. When utilized in a single step or single phase process these precipitated metals can enrich the resulting extracted solids (e.g. calcium-depleted steel slag) fraction of such a process. Alternatively, when utilized in a multi-step or multi-phase process, for example one in which a soluble metal salt of the spent pickle liquor (e.g. ferrous chloride) is converted to an insoluble metal hydroxide and isolated separately from the remaining calcium-depleted steel slag residue, a separate and potentially valuable product stream can be generated while also regenerating the lixiviant. For example, once ferrous chloride is isolated a variety of other materials can be made from it, including but not limited to iron-based chemicals, iron oxides, iron metal, and steel.

It should be appreciated that solid wastes of steel production such as steel slag are often sent to a landfill or collected in piles for indefinite storage, and that spent pickle liquor requires relatively expensive neutralization before disposal. The combination of these two waste streams advantageously both reduces waste volume and generates multiple value-added products. Furthermore, Inventors have surprisingly found that the use of relatively small (in some embodiments, substoichiometric) amounts of lixiviant allows production of a relatively high purity (e.g. greater than 80%) iron hydroxide precipitate. Ultimately, regeneration and recycling of the lixiviant species reduces lixiviant consumption even further.

Embodiments of the inventive concept combine high-volume waste streams from the steel making industry to generate commercially valuable purified products as well as stabilized residues. In some embodiments spent pickle liquor from a steel making process, which includes a water soluble iron salt (such as ferrous chloride/FeCl₂), is added to a slurry resulting from treatment of metal-containing steel slag with an aqueous phase lixiviant (such as an organic amine) to produce a metal-depleted slag residue and a spent lixiviant. The lixiviant serves to selectively extract the metal from the steel slag, for example by generating a solution of highly purified metal chloride as well as a metal-depleted slag residue. The resulting spent lixiviant can be regenerated in situ as the process is carried out, for example by an HCl or other acid component of the spent pickle liquor and/or by FeCl₂ of the spent pickle liquor. Simultaneously, the FeCl₂ in the spent pickle liquor can undergo a metathesis reaction with calcium hydroxide of the steel slag to generate highly insoluble ferrous hydroxide (Fe(OH)₂) and soluble calcium chloride. Precipitation of the Fe(OH)₂ enriches the iron content of the solids left after the process. In preferred embodiments the metal is calcium.

In another embodiment of the inventive concept spent pickle liquor is added to an aqueous solution derived from lixiviant treatment of steel slag or a similar raw material, for example in a separate reactor downstream from a filter at the outlet of the slurry reactor that serves to separate metal-depleted slag resulting from lixiviant treatment from the aqueous phase containing spent lixiviant. The spent lixiviant is subsequently regenerated by treatment with spent pickle liquor. Such lixiviant can be present in stoichiometric, superstoichiometric (i.e. molar excess), or substoichiometric amounts relative to metal content of the steel slag or other raw material. If the stoichiometry of the chloride content of the spent pickle liquor (for example, from FeCl₂ and/or HCl)) is at or below the equivalent of spent lixiviant Fe(OH)₂ precipitates within this reactor and can be separated (for example, by an additional filtration module), while the regenerated lixiviant is returned to an extractor for use in selectively extracting metal from steel slag or other raw material, returning to the reaction cycle to generate additional metal chloride solution and spent lixiviant. Such a chloride-limited regeneration process allows for isolation of a highly purified (e.g. greater than 80% pure) ferrous hydroxide product as well as a metal chloride solution (from which the metal can be recovered) and metal-depleted slag. In preferred embodiments the metal is calcium.

Alternatively, if the above described process is performed in an acid-limited regeneration mode, in which the added acid in the spent pickle liquor (for example, the HCl content of the spent pickle liquor) is provided at or below the molar equivalent of spent lixiviant, Fe(OH)₂ will initially be formed and precipitate. However, this precipitated Fe(OH)₂ will re-form a soluble Fe salt (for example FeCl₂) as the acid equivalence point is approached. If this solution is returned to the steel slag extractor, the products are the same as the single phase process described above, in which ferrous hydroxide is precipitated within the extractor and joins the metal-extracted steel slag.

Selective extraction of calcium and other metals from slag and other metal containing materials to make a metal salt solution through the use of a lixiviant that is regenerated in situ has been previously disclosed by the Inventors (US patent numbers here). The described processes describe the use of acids for lixiviant regeneration. Herein, the process is shown to be modifiable such that the material used for regenerating the selective lixiviant can include other active components and/or contaminants beyond the acid, and that these additional components can be managed or utilized in different ways. For example, a calcium can be recovered from steel slag (for example, BOF slag as in the examples provided), a lixiviant, and spent pickle liquor. Steel pickling is a process that involves treating the metal alloy with a strong acid, most commonly hydrochloric acid (HCl), however sulfuric acid (H₂SO₄) can also be used. The steel pickling process generates a significant volume of waste solution referred to as spent pickle liquor, which primarily contains dissolved iron salts as well as some residual acid. When HCl is used the spent pickle liquor contains ferrous chloride (FeCl₂) and some unreacted HCl. When H₂SO₄ is used the spent pickle liquor contains ferrous sulfate (FeSO₄) and some unreacted H₂SO₄, and may additionally contain ferric sulfate (Fe₂(SO₄)₃) and sulfurous acid (H₂SO₃) generated by redox reactions between iron and sulfur. Iron content of spent steel pickle liquors is typically at or near saturation for the corresponding iron salt, and can be significant (e.g. up to 25% by weight for H₂SO₄ pickling solutions), making spent pickle solutions attractive sources of iron.

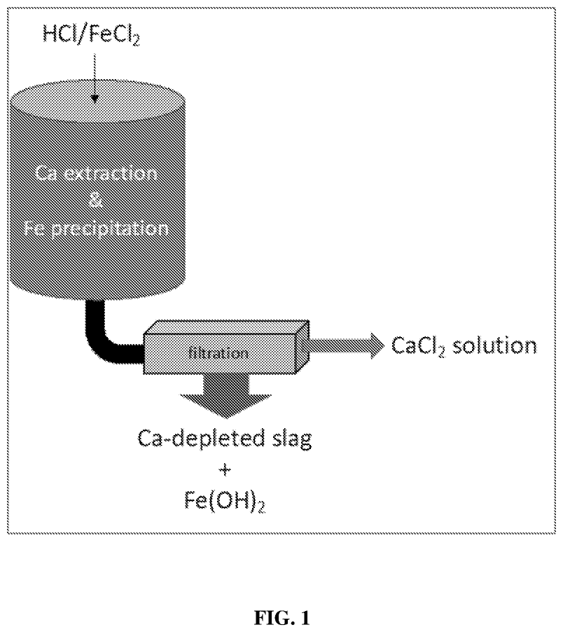

FIG. 1 shows an example of utilizing HCl-based steel pickling waste in an integrated process that also generates calcium chloride solution from steel slag. In such a process steel slag is added to an aqueous solution containing a significantly sub-stoichiometric quantity of a lixiviant (e.g. 10% of calcium content, 1% of calcium content, etc.) relative to the amount of extractable calcium within the steel slag. Suitable lixiviants are typically protonated amine salts (for example, an organic amine) but are not limited to this class of compounds. For simplicity, the lixiviant in the following description is assumed to be in the form of a hydrochloride salt, abbreviated as HLixCl. The vessel which holds this starting mixture is referred to as an extractor. The mixture within the extractor does not need to be agitated, however providing ample agitation to suspend solids can help to improve the reaction kinetics. Immediately upon contact between the slag and the lixiviant solution, selective extraction of calcium occurs until the available lixiviant (HLixCl) is consumed, leaving spent lixiviant (Lix) and calcium chloride in the solution phase (Error! Reference source not found.), along with calcium-depleted slag.

Ca(OH)₂2HLixCL→CaCl₂+2H₂O+2Lix Equation 1

Consumption of lixiviant can be observed by an increase in the solution's pH, due to consumption of weakly acidic lixiviant, generation of basic spent lixiviant, and potentially partial dissolution of calcium hydroxide.

For simplicity, it is assumed that the extractable calcium within the steel slag is in the form of slaked lime (Ca(OH)₂) resulting from contact with water, however similar selective reactions are possible for other calcium oxides and minerals, for example unslaked lime (CaO) or calcium silicate (CaSiO₃), as well as other metastable calcium silicates such as, but not limited to Ca₃SiO₅. Furthermore, it should be appreciated that the slight solubility of Ca(OH)₂ can result in the reaction of lixiviant with calcium hydroxide in the aqueous phase. The mechanism by which the reaction occurs irrelevant; selective extraction of calcium occurs necessarily.

Alternatively, a process of the inventive concept can be initiated by adding lixiviant to a steel slag and water mixture, which would result in the same or substantially the same product distribution. In some embodiments spent lixiviant (Lix) can be used to start the process, in which case no initial reaction would take place. Regardless, spent lixiviant can be regenerated in a subsequent step as shown in Equation 1. In this exemplary reaction the spent lixiviant molecule can be reprotonated by the acid component of a spent pickle liquor.

Lix+HCl→HLixCl Equation 1

In some embodiments a spent lixiviant in a mixture of treated steel slag and spent lixiviant can be regenerated using a spent pickle liquor. While there is potential for free HCl or other acids in a spent pickle liquor to react directly with the steel slag solids (possibly extracting unwanted materials (e.g. Mg, Al, Mn, etc.) exists, Inventors have surprisingly found that this does not appear to occur to any significant extent. Without wishing to be bound by theory Inventors believe that reaction kinetics strongly favor reprotonation of the spent lixiviant since this is a completely aqueous phase reaction, aided by extremely rapid proton mobility within aqueous solutions. Reaction with the solids would be inter-phase, therefore, slower. As long as the amount of HCl added at any one time does not exceed the amount of spent lixiviant in solution, the lixiviant regeneration reaction was found to be favored. By keeping the added aliquots of HCl below, say, 90% of the stoichiometric equivalent of lixiviant, the potential to leach unwanted materials directly from the steel slag via HCl was found to be negligible. Additionally, the Inventors believe that the partial solubility of slaked lime in the solution helps to prevent any unwanted reactions of the strong acid with steel slag solids.

Since the spent pickle liquor also contains considerable amounts of ferrous chloride an additional reaction occurs involving the spent lixiviant in which insoluble ferrous hydroxide is generated as well as the regenerated lixiviant (see Equation 2). It is should be appreciated that spent pickle liquor does not need to contain any free HCl to be useful in methods of the inventive concept, as the FeCl₂ content alone can effectively regenerate the spent lixiviant. In some embodiments of the inventive concept (see FIG. 1) the spent pickle liquor can be added (for example, in the form of multiple appropriately sized aliquots) directly to a stirred extractor tank, resulting in precipitation of Fe(OH)₂ within the reactor.

2Lix+FeCl₂+2H₂O→2HLixCl+Fe(OH)₂ Equation 2

Inventors contemplate that a direct reaction between ferrous chloride and calcium hydroxide can also occur, given the partial solubility of the latter (see Equation 3). However, the net result is the same as if the reaction took place through the lixiviant intermediate and therefore does not impact on the overall process.

FeCl₂+Ca(OH)₂→CaCl₂+Fe(OH)₂ Equation 3

It should be appreciated that kinetics of the above described reactions can be impacted by various factors, including the particle size of the steel slag (or other raw material) and the amount of remaining extractable metal within the steel slag. If the reaction kinetics between the active aqueous phase reagents and the raw material solids are appreciably slow (e.g. due to large particle sizes, low remaining extractable calcium, etc.), then a situation can arise where added HCl can transiently re-dissolve a portion of the precipitated iron salt. Overall, as long as the lixiviant stoichiometry is not exceeded by the HCl or other acid added, no appreciable amount of undesired extraction occur and selective extraction of calcium will proceed via the reactions in Error! Reference source not found. and Equation 3.

When multiple aliquots of spent pickle liquor are applied to steel slag or other suitable raw material the above reactions occur with each addition, generating calcium chloride solution and ferrous hydroxide solids. Monitoring the pH of the reactant solution permits optimization of the appropriate time for addition of spent pickle liquor and also ensures that the lixiviant stoichiometry is not exceeded. When the desired amount of extractable calcium has been converted to calcium chloride solution the solution can be separated from the solids via filtration, centrifugation, settling, or other appropriate means. In such a process the solids will contain a mixture of calcium-depleted slag and ferrous hydroxide, providing an expansion-stabilized, iron-enriched solid. Such a solid has a number of uses, including being recycled back into the steel making process or as fillers in asphalt or concrete.

Although washing and drying of solids so generated is not be necessary, it should be noted that if the ferrous hydroxide so produced is dried in the presence of air it is readily oxidized to form iron (III) compounds like ferric oxide-hydroxide (i.e. ferric acid, Equation 4).

4Fe(OH)₂+O₂→4FeOOH+2H₂O Equation 4

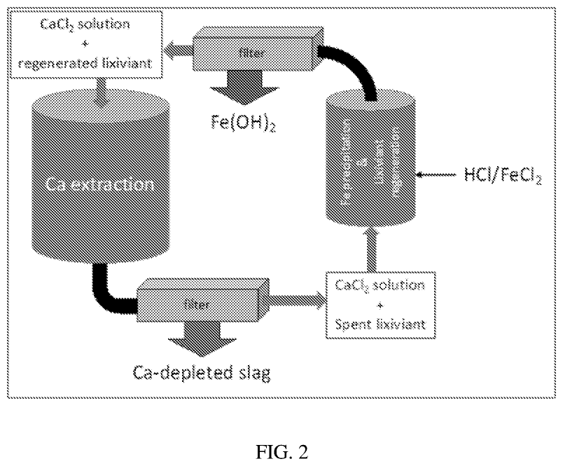

Another method of the inventive concept is shown in FIG. 2. Initial steps of the process are similar to those described above, however the solution phase containing the spent lixiviant is separated from the depleted steel slag prior to the addition of spent pickle liquor. This can be done in a continuous manner or a batch-wise manner. In preferred embodiments such a separation is performed in a continuous manner. The filtered solution is transferred to a separate secondary reactor where the lixiviant is regenerated by addition of spent pickle liquor as described above. In such embodiments reaction between calcium hydroxide and HCl or FeCl₂ of the spent pickle liquor is greatly limited by the solubility of slaked lime in the solution. Therefore, the chemistry of the process is dominated by Equation 1 and Equation 2. Lixiviant regeneration (as well as calcium extraction) can be monitored by pH. When the total amount of chloride added from the spent pickle liquor is below the stoichiometric equivalent of the spent lixiviant in the secondary reactor the FeC₂ is converted to Fe(OH)₂ which precipitates from solution (Equation 2). Surprisingly, the Inventors have found that the resulting Fe(OH)₂ is of high purity (greater than 80%, 85%, 90%, 95%, or 98%). The resulting dark green solid can be isolated by filtration, centrifugation, settling, or other appropriate methods, and the aqueous phase containing the regenerated lixiviant recycled back to the extraction tank, where it will continue to react selectively with extractable calcium in the slag (Error! Reference source not found.). Lixiviant regeneration (and ferrous hydroxide precipitation) can be carried out in a separate reactor from that utilized for steel slag or other suitable raw material extraction step until the desired amount of extractable calcium has been obtained. Such segregated methods advantageously provide three distinct product streams from waste products of steel production that would otherwise have been disposed of to the environment; purified calcium salt solution, purified ferrous hydroxide (can be air oxidized to ferric acid), and calcium depleted (stabilized) slag.

It should be appreciated that in some embodiments of the two-step process shown in FIG. 2, the primary reactor need not be an enclosed reactor or containing vessel. For example, a heap or pile of solid raw material (e.g. steel slag) can be contacted with a lixiviant that is allowed to pass through at least a portion of the heap or pile, with spent lixiviant and extracted metal in solution collected as runoff from this initial step. In such embodiments the heap or pile of solid raw material can be considered an open reactor. Later reactions, for example regeneration of spent lixiviant using pickle liquor, can be performed in a secondary reactor and the regenerated lixiviant returned to the heap or pile of raw material for further extraction.

In some embodiments the amount of added pickle liquor can be added to such a secondary reactor in amounts that exceed the chloride equivalent of Equations 2 and 3 and that approach (but not exceed) the acid equivalent of Equation 4. In such embodiments a portion of the ferrous hydroxide can convert back to ferric chloride within the secondary reactor. The resulting solution phase, when recycled back to the primary reactor/extractor, can react with extractable calcium (or other metals) present in the steel slag/raw material according to Error! Reference source not found. and Equation 3 in a manner similar to that of the single reactor process described above. Similarly, some ferrous hydroxide would precipitate in the primary reactor/extractor and the solids product stream would include calcium-depleted slag and Fe(OH)₂. While such embodiments do not provide fully separated solids streams they do offer improved reaction control and monitoring through regeneration of the lixiviant in a separate reactor.

It should be appreciated that in both single reactor and two reactor configurations the lixiviant is regenerated and recycled back into the integrated process. As such, even if substoichiometric amounts of lixiviant are not utilized the overall consumption of lixiviant is minimal and essentially limited to inevitable process losses.

Inevitably, the calcium (or other extracted metal) salt solutions produced by methods of the inventive concept will contain a certain amount of residual spent lixiviant. Inventors have found that this can be minimized by using a high slag/raw material to lixiviant ratio. In some applications of the calcium (or other extracted metal) salt solutions so produced such residual lixiviant content may be inconsequential, permitting direct utilization. In other applications where residual lixiviant is not tolerated it can be removed using sorbents, dialysis, diafiltration, and other methods. In some embodiments a lixiviant species can be selected that has low (e.g. less than 10%) solubility in water or is water insoluble when the lixiviant is in spent form, thereby facilitating removal, but that is water soluble in its active form (e.g. as an HCl salt). Such a lixiviant can be applied to a single reactor process as described above, with spent lixiviant co-locating with the depleted raw material. In such embodiments the spent lixiviant can be recovered from the depleted raw material in a separate step, for example by application of a spent pickle liquor or mineral acid, for recycling into the process.

In some embodiments of the inventive concept, calcium and/or other metal salts can be recovered from spent lixiviant by exploiting the temperature-dependent nature of the metal salt's solubility. For example, the temperature of a spent lixiviant mixture containing CaCl₂ can be reduced to a point where the concentration of CaCl₂ present exceeds the saturation limit and crystallizes or precipitates from solution. Calcium can be recovered from the crystallized or precipitated CaCl₂, and the resulting lixiviant mixture recycled into the process as described above. In some embodiments it can be necessary to replace water lost to formation of metal salt crystals to such solutions.

It should be appreciated that, while steel slag is noted as a suitable raw material above, other raw materials containing metals of commercial value (such as calcium) are also suitable for use in methods of the inventive concept. For example, impure or low-quality lime, dololime, and other calcium-containing minerals are suitable for use as raw materials in processes that utilize spent pickle liquor to regenerate a lixiviant and provide a source of high purity iron.

In some embodiments of the inventive concept spent lixiviant can be regenerated by the addition of a solution of a soluble metal chloride, for example MgCl₂. In such embodiments regeneration of the lixiviant is accompanied by the generation of an insoluble metal hydroxide (for example, Mg(OH)₂), with the regenerated lixiviant being utilized in the recovery of specific metals (such as calcium) from suitable raw materials, including steel slag or lime. It should be appreciated that direct addition of such metal chlorides to calcium-containing raw materials can lead to trapping of significant quantities of calcium in the precipitating metal hydroxide, which can in turn lead to process inefficiencies and/or lower purity products.

While HCl-based pickle formulations are commonly used in the processing of steel and have been cited in an exemplary fashion above, it should be appreciated that other spent pickle formulations (e.g. derived HBr, H₂SO₄, H₂NO₃, etc. based pickle liquors) are suitable. In some embodiments mixed spent pickle formulations (e.g. based on HCl and HBr and containing FeCl₂ and FeBr₂) can be utilized.

Inventors contemplate that the compositions and methods described above can be applied to other metal processing operations where pickling surface treatment is applied, for example aluminum and copper processing. In such embodiments these metal processing operations can be coupled with steel processing (for example, through the use of steel slag) to provide highly integrated metal processing systems that produce minimal waste and optimize recovery of valuable metals.

Organic amines suitable for use as a lixiviant can have the general formula shown in Compound 1, where N is nitrogen, H is hydrogen, and X is a counterion (i.e., a counter anion).

Ny,R₁,R₂,R₃,H—Xz Compound 1

Suitable counterions can be any form or combination of atoms or molecules that produce the effect of a negative charge. Counterions can be halides (for example fluoride, chloride, bromide, and iodide), anions derived from mineral acids (for example nitrate, phosphate, bisulfate, sulfate, silicates), anions derived from organic acids (for example carboxylate, citrate, malate, acetate, thioacetate, propionate and, lactate), organic molecules or biomolecules (for example acidic proteins or peptides, amino acids, nucleic acids, and fatty acids), and others (for example zwitterions and basic synthetic polymers).

A wide variety of ionic compounds are suitable for use as lixiviant species. For example, ammonium chloride, ammonium bromide, ammonium acetate, ammonium fluoride, ammonium propionate, ammonium lactate, ammonium nitrate, any combination of a strong acid and a weak base, any combination of any weak base and a weak acid, any combination of a strong base and weak acid, any combination of a strong base and a strong acid, naturally occurring or non-naturally occurring amino acids, and monoethanolamine hydrochloride are contemplated as suitable lixiviant species.

It should be appreciated that a variety of compounds are suitable for extraction of metals from steel slags, including carboxylic acids, ammonium salts, and organic compounds that incorporate one or more amine moieties (organic amines). Organic amines suitable for the extraction of metals from steel slags and/or other sources can have a pKa of about 7 to about 14 or about 8 to about 14, and can include protonated ammonium salts (i.e., not quaternary). In preferred embodiments, the organic amines used to extract alkali metal elements are in a pKa range of about 8 to about 12. In more preferred embodiments, the organic amines used to extract alkali metal elements are in a pKa range of about 8.5 to about 11. In the even more preferred embodiments, the organic amines are in a pKa range of about 9 to about 10.5. Examples of suitable organic amines for use in lixiviants include weak bases such as ammonia, nitrogen containing organic compounds (for example monoethanolamine, diethanolamine, triethanolamine, morpholine, ethylene diamine, diethylenetriamine, triethylenetetramine, methylamine, ethylamine, propylamine, dipropylamines, butylamines, diaminopropane, triethylamine, dimethylamine, and trimethylamine), low molecular weight biological molecules (for example glucosamine, amino sugars, tetraethylenepentamine, amino acids, polyethyleneimine, spermidine, spermine, putrescine, cadaverine, hexamethylenediamine, tetraethylmethylenediamine, polyethyleneamine, cathine, isopropylamine, and a cationic lipid), biomolecule polymers (for example chitosan, polylysine, polyornithine, polyarginine, a cationic protein or peptide), and others (for example a dendritic polyamine, a polycationic polymeric or oligomeric material, and a cationic lipid-like material), or combinations of these. In some embodiments of the inventive concept the organic amine can be monoethanolamine, diethanolamine, or triethanolamine, which in cationic form can be paired with nitrate, bromide, chloride or acetate anions. In other embodiments of the inventive concept the organic amine can be lysine or glycine, which in cationic form can be paired with chloride or acetate anions. In a preferred embodiment of the inventive concept the organic amine is monoethanolamine, which in cationic form can be paired with a chlorine anion.

Such organic amines can range in purity from about 50% to about 100%. For example, an organic amine of the inventive concept can have a purity of about 50%, about 55%, about 60%, about 65%, about 70%, about 75%, about 80%, about 85%, about 90%, about 95%, about 97%, about 99%, or about 100%. In a preferred embodiment of the inventive concept the organic amine is supplied at a purity of about 90% to about 100%. It should be appreciated that organic amines can differ in their ability to interact with different metal oxides/hydroxides and with contaminating species, and that such selectivity can be utilized to provide highly selective recovery of a desired metal from a mixture present in a raw material.

Inventors further contemplate that zwitterionic species can be used in suitable lixiviants, and that such zwitterionic species can form cation/counterion pairs with two members of the same or of different molecular species. Examples include amine containing acids (for example amino acids and 3-aminopropanoic acid), chelating agents (for example ethylenediamine-tetraacetic acid and salts thereof, ethylene glycol tetraacetic acid and salts thereof, diethylene triamine pentaacetic acid and salts thereof, and 1,2-bis(o-aminophenoxy)ethane-N,N,N′,N′-tetraacetic acid and salts thereof), and others (for example betaines, ylides, and polyaminocarboxylic acids).

Organic amines for use in lixiviants can be selected to have minimal environmental impact. The use of biologically derived organic amines, such as glycine, is a sustainable practice and has the beneficial effect of making processes of the inventive concept more environmentally sound. In addition, it should be appreciated that some organic amines, such as monoethanol-amine, have a very low tendency to volatilize during processing. In some embodiments of the inventive concept an organic amine can be a low volatility organic amine (i.e., having a vapor pressure less than or equal to about 1% that of ammonia under process conditions). In preferred embodiments of the inventive concept, the organic amine is a non-volatile organic amine (i.e., having a vapor pressure less than or equal to about 0.1% that of ammonia under process conditions). Capture and control of such low volatility and non-volatile organic amines requires relatively little energy and can utilize simple equipment. This reduces the likelihood of such low volatility and non-volatile organic amines escaping into the atmosphere and advantageously reduces the environmental impact of their use.

Preferred organic amines can include: Methoxylamine hydrochloride solution, Ethanolamine ACS reagent, Ethanolamine, Ethanolamine hydrochloride, N-(Hydroxymethyl)acetamide, 2-(Methylamino)ethanol, 2-Methoxyethylamine, 3-Amino-1-propanol, Amino-2-propanol, DL-Alaninol, 3-Amino-1,2-propanediol, Serinol, 1,3-Diamino-2-propanol, N-(2-Hydroxyethyl)trifluoroacetamide, N-Acetylethanolamine technical grade, 1-Amino-2-methyl-2-propanol 95% anhydrous basis, 1-Methoxy-2-propylamine, 2-(Ethylamino)ethanol, 2-Amino-1-butanol, 2-Amino-2-methyl-1-propanol, 2-Dimethylaminoethanol, 3-Methoxypropylamine, 3-Methylamino-1-propanol, 4-Amino-1-butanol, 2-(2-Aminoethoxy)ethanol, 3-Methylamino-1,2-propanediol, Diethanolamine, Diethanolamine ACS reagent, Diethanolamine hydrochloride, Tris(hydroxymethyl)aminomethane ACS reagent, 2-(Ethylthio)ethylamine hydrochloride, 2,2′-Oxydiethylamine dihydrochloride, N-(2-Hydroxyethyl)ethylenediamine, meso-1,4-Diamino-2,3-butanediol dihydrochloride, Cystamine dihydrochloride, N-(3-Hydroxypropyl)trifluoroacetamide, trans-2-Aminocyclopentanol hydrochloride, 2-Methylaminomethyl-1,3-dioxolane, 1-Dimethylamino-2-propanol, 2-(Isopropylamino)ethanol, 2-(Propylamino)ethanol, 2-Amino-3-methyl-1-butanol, 3-Dimethylamino-1-propanol, 3-Ethoxypropylamine, 5-Amino-1-pentanol, DL-2-Amino-1-pentanol, 3-(Dimethylamino)-1,2-propanediol, N-Methyldiethanolamine, 2-(3-Aminopropylamino)ethanol, N-(4-Hydroxybutyl)trifluoroacetamide, 1-Amino-1-cyclopentanemethanol, trans-2-Aminocyclohexanol hydrochloride, trans-4-Aminocyclohexanol hydrochloride, 2-(Butylamino)ethanol, 2-(Diethylamino)ethanol, 2-(tert-Butylamino)ethanol, 2-Dimethylamino-2-methylpropanol, 4-(Dimethylamino)-1-butanol, 6-Amino-1-hexanol, DL-2-Amino-1-hexanol, Bis(2-hydroxypropyl)amine, Bis(2-methoxyethyl)amine, N-Ethyldiethanolamine, Triethanolamine reagent grade, L-Leucinol hydrochloride, N,N′-Bis(2-hydroxyethyl)ethylenediamine, 5-Amino-2-chlorobenzyl alcohol, 2-Aminobenzyl alcohol, 3-Aminobenzyl alcohol, 4-Aminobenzyl alcohol, 2-Amino-4-methoxyphenol, 3,4-Dihydroxybenzylamine hydrobromide, 3,5-Diaminobenzyl alcohol dihydrochloride, N-(5-Hydroxypentyl)trifluoroacetamide, 3-(Allyloxycarbonylamino)-1-propanol, 1-Aminomethyl-1-cyclohexanol hydrochloride, trans-2-(Aminomethyl)cyclohexanol hydrochloride, N-Boc-ethanolamine, 3-Butoxypropylamine, 3-Diethylamino-1-propanol, 5-Amino-2,2-dimethylpentanol, 3-(Diethylamino)-1,2-propanediol, 1,3-Bis(dimethylamino)-2-propanol, 2-{[2-(Dimethylamino)ethyl]methylamino}ethanol, 4-Chloro-N-(2-hydroxyethyl)-2-nitro aniline, 2-Amino-1-phenylethanol, 2-Amino-3-methylbenzyl alcohol, 2-Amino-5-methylbenzyl alcohol, 2-Aminophenethyl alcohol, 3-Amino-2-methylbenzyl alcohol, 3-Amino-4-methylbenzyl alcohol, 4-(1-Hydroxyethyl)aniline, 4-Aminophenethyl alcohol, N-(2-Hydroxyethyl)aniline, 3-Hydroxy-4-methoxybenzylamine hydrochloride, 3-Hydroxytyramine hydrobromide, 4-Hydroxy-3-methoxybenzylamine hydrochloride, Norphenylephrine hydrochloride, 5-Hydroxydopamine hydrochloride, 6-Hydroxydopamine hydrobromide, DL-Norepinephrine hydrochloride crystalline, N-(6-Hydroxyhexyl)trifluoroacetamide, 4-Diethylamino-2-butyn-1-ol, Tropine, 3-(Boc-amino)-1-propanol, N-Boc-DL-2-amino-1-propanol, N-Boc-serinol, 2-(Diisopropylamino)ethanol, N-Butyldiethanolamine, N-tert-Butyldiethanolamine, DL-4-Chlorophenylalaninol, 2-(Methylphenylamino)ethanol, 2-Benzylaminoethanol, 3-(Dimethylamino)benzyl alcohol, α-(Methylaminomethyl)benzyl alcohol, 4-(Boc-amino)-1-butanol, N-Boc-DL-2-amino-1-butanol, N-Boc-2-amino-2-methyl-1-propanol, N—Z-Ethanolamine, 2[4-(Dimethylamino)phenyl]ethanol, 2-(N-Ethylanilino)ethanol, α-[2-(Methylamino)ethyl]benzyl alcohol, Ephedrine hydrochloride, N-Benzyl-N-methylethanolamine, 3,5-Dimethoxyphenethylamine, N-Phenyldiethanolamine, Metanephrine hydrochloride, 3-Amino-1-adamantanol, 6-(Allyloxycarbonylamino)-1-hexanol, 5-(Boc-amino)-1-pentanol, N-Boc-DL-2-amino-1-pentanol, 2-(Dibutylamino)ethanol, Benzyl N-(3-hydroxypropyl)carbamate, N-Boc-4-hydroxyaniline, N-(Benzyloxycarbonyl)-3-amino-1,2-propanediol, 2-(N-Ethyl-N-m-toluidino)ethanol, 2,2′-(4-Methylphenylimino)diethanol, N4-Ethyl-N4-(2-hydroxyethyl)-2-methyl-1,4-phenylenediamine sulfate salt, N-Boc-1-amino-1-cyclopentanemethanol, Choline dihydrogen citrate salt, 6-(Boc-amino)-1-hexanol, N-Boc-DL-2-amino-1-hexanol, 4-(Z-Amino)-1-butanol, 2,2′-[4-(2-Hydroxyethylamino)-3-nitrophenylimino]diethanol, 5-(Z-Amino)-1-pentanol, 4-Acetylamino-2-(bis(2-hydroxyethyl)amino)anisole, 3-[Bis(2-hydroxyethyl)amino]propyl-triethoxysilane solution technical, 4-(Z-amino)cyclohexanol, Oxolamine citrate salt, 6-(Z-Amino)-1-hexanol, 2,2-Bis(3-amino-4-hydroxyphenyl)hexafluoropropane, Tris[2-(2-methoxyethoxy)ethyl]amine, 8-Hydroxy-2-(dipropylamino)tetralin hydrobromide, 2-(Fmoc-amino)ethanol, 3-(Dibenzylamino)-1-propanol, 3-(Fmoc-amino)-1-propanol, 4-(Fmoc-amino)-1-butanol, 2-[2-(Fmoc-amino)ethoxy]ethanol, 5-(Fmoc-amino)-1-pentanol, 6-(Fmoc-amino)-1-hexanol, trans-2-(Fmoc-aminomethyl)cyclohexanol, N,N-Bis[2-(p-tolylsulfonyloxy)ethyl]-p-toluenesulfonamide, and (Hydroxymethyl)benzoguanamine, methylated/ethylated.

Preferred organic amines can also include polymer-based amines and salts including, for example, polyetheneimine hydrochloride. Preferred organic amines can also include mixtures of polyamines and/or polyacids and amines, including, for example, polyacrylic acid and ammonia.

Inorganic amines can also be selected for use in lixiviants. Inorganic amines, or azanes, are inorganic nitrogen compounds with the general formula NR₃. Inorganic amines can include ammonia, ammonia borane, ammonium chloride, ammonium acetate, ammonium nitrate, ammonium bromide, chloramine, dichloramine, hydroxylamine, nitrogen tribromide, nitrogen trichloride, nitrogen trifluoride, and nitrogen triiodide. In some embodiments of the inventive concept, an inorganic amine with low vapor pressure relative to other inorganic amines can be used to prevent the off-gassing of inorganic amines.

### EXAMPLES

Example 1: A mock spent pickle liquor solution was prepared by adding 54.1 g of 37% HCl to 83.2 g of water. To the HCl solution, 62.7 g of FeCl₂.2H₂O was added and the mixture stirred until the ferric chloride completely dissolved. The resulting solution was medium green in color (very much like pickle juice), containing 10% HCl and 20% FeCl₂ by weight.

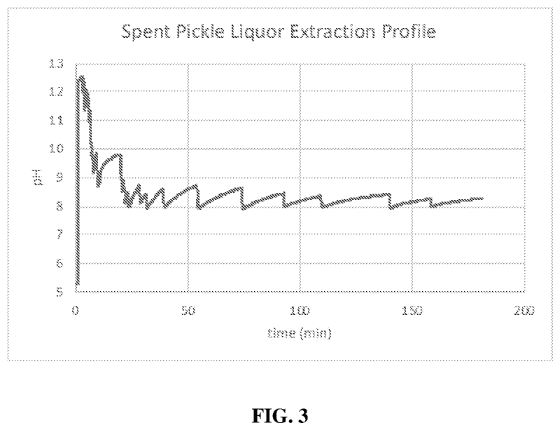

A 500 ml beaker was charged with 300 g water and 2.00 g monoethanolamine hydrochloride (MEAC1) selected as a lixiviant. The resulting solution was magnetically stirred at 500 rpm and a pH probe with data logger was placed in the solution. The pH of the solution was measured at about 5.3. 30 g of BOF slag (<125 μm particle size), previously determined to have 17.4% extractable CaO, was added to the MEACl solution. The solution pH rapidly rose to about 12.5. Aliquots of the mock spent pickle liquor were then added to the stirred slurry, with the pH of the suspension allowed to recover (indicating extraction of calcium from the slag) between additions. The maximum weight of spent pickle liquor added in a single aliquot before waiting for pH recovery was 4.75 g in order to avoid exceeding the stoichiometric limit of the lixiviant. The pH was monitored closely, and measures taken to avoid dropping below a pH of 8. Initially, the pH of solution recovered faster than the spent pickle liquor aliquots could be added and the pH of solution dropped slowly. Over time larger decreases in the pH were observed with further additions of spent pickle liquor, and longer recovery times were necessary. The pH changes over time with multiple additions of spent pickle liquor are show in FIG. 3. As the reaction proceeded, the color of the slurry was observed to change from a dark brown (typical of slag) color to dark green, indicating the generation of Fe(OH)₂ solids. The total amount of mock spent pickle liquor added was 55.96 g.

After the desired amount of calcium had been extracted, the mixture was filtered, and the solids washed twice with about 50 ml water, to yield 363.1 g of clear, colorless solution and a dark green solid. The solids were dried to a constant weight of 28.39 g. On drying the color of the solids changed from dark green to a rusty orange color, consistent with oxidation of iron(II) to iron(III).

Based on the amount of spent pickle liquor added, the solution phase obtained should contain 4.0% by weight CaCl₂. LOD for a small sample of this solution was 95.1% at 105 ° C. Assuming the final, white crystallize residue was calcium chloride monohydrate, this would correspond the solution phase being a 3.7% CaCl₂ solution- very close to experimental estimates. ICPMS analysis of the solution shows excellent selectivity for Ca above all other metals analyzed (Mg, Al, Si, Fe, Mn).

Example 2: In a 500 ml beaker, 1.25 g MEA was diluted into 300 g water and the solution magnetically stirred at 500 rpm. One chloride equivalent (4.75 g) of mock spent pickle liquor (prepared in Example 1), relative to MEA, was added to the stirred solution. A dark green precipitate formed, consistent with generation of ferrous hydroxide. The solution pH was measured to be about 8. With continued stirring, an additional 2.73 g of mock spent pickle liquor was added such as to bring the total acid up to equivalence with MEA. The solution re-clarified, having a yellow/orange color and a pH between 3 and 4.

Example 3: In a 500 ml beaker, 1.25 g MEA was diluted into 300 g water and the solution magnetically stirred at 500 rpm. To this, 6.0 g of CaCl₂.2H₂O was added, providing a CaCl₂ loading (1.5%) similar to a partial extraction like that described in Example 1. One chloride equivalent (4.75 g) of mock spent pickle liquor (prepared in Example 1), relative to MEA, was added to the stirred solution. A dark green precipitate formed, consistent with formation of ferrous hydroxide. With continued stirring, an additional 2.73 g of mock spent pickle liquor was added such as to bring the total acid up to equivalence with MEA. The solution re-clarified, and the resulting solution had a yellow/orange color.

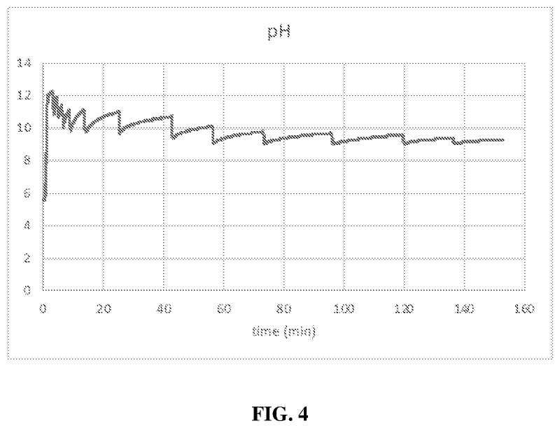

Example 4: A 500 ml beaker was charged with 300 g water and 3.00 g lysine hydrochloride (Lys⋅HCl) to act as a lixiviant. The resulting solution was magnetically stirred at 500 rpm and a pH probe with data logger placed in the solution. The pH of the solution was determined to be about 5.6. 30 g of BOF slag (<3 mm particle size), previously determined to have 16.8% extractable CaO, was then added. The solution pH rapidly rose to about 12.2. Aliquots of the mock spent pickle liquor prepared in Example 1 were added to the stirred slurry as described above. The maximum weight of spent pickle liquor added in a single aliquot before waiting for pH recovery was 3.80 g in order to avoid exceeding the stoichiometric limit of the lixiviant. Additionally, the pH was monitored closely, and measures taken to avoid dropping below a pH of 9. Initially, the pH of solution recovered very quickly (indicating recovery of calcium from the slag), such that multiple aliquots of acid could be added in fairly rapid succession. Recovery was not as rapid as observed in Example 1, presumably due to the larger slag particle size and resulting slower kinetics. Eventually, more drastic decreases in pH were observed with further additions of spent pickle liquor, and longer recovery times were necessary. The pH changes over time with repeated additions of spent pickle liquor are shown FIG. 4. As the reaction proceeded the color of the slurry changed from a dark brown color (typical of slag) to dark green, consistent with generation of Fe(OH)₂ solids. The total amount of mock spent pickle liquor added was 32.30 g.

After the desired amount of calcium had been extracted, the mixture was filtered, and the solids washed twice with about 50 ml water, to yield 361.9 g of clear, colorless solution and a dark green solid. The solids were dried to a constant weight of 25.64 g. The solids had changed from dark green to a rusty orange color, consistent with oxidation of iron(II) to iron(III).

LOD for a small sample of the solution was 95.9% at 105° C. Assuming the final, white crystallize residue was calcium chloride monohydrate, this would correspond to 3.56% CaCl₂ solution. ICPMS analysis of the solution shows very little metal impurities for those analyzed (Mg, Al, Si, Fe, Mn).

Example 5: In a 250 ml vessel (hereby referred to as the regeneration or precipitation vessel), 1.14 g monoethanolamine (MEA) was diluted with 150 g of water and stirred at 450 rpm. A pH probe, connected to a datalogger, was placed in the solution and the solution pH recorded at 5 second intervals. The chloride equivalent of spent pickle liquor (prepared as in Example 1), was determined to be 4.30 g for the full MEA loading. 4.28 g of spent pickle liquor was added to the stirred MEA solution (an example of a spent lixiviant), precipitating a dark green solid consistent with the formation of Fe(OH)₂. The mixture was allowed to stir for an additional minute, letting the pH stabilize. The pH logger was paused and the probe removed from the precipitation vessel. The suspension was filtered, separating the ferrous hydroxide solid from the clear, colorless lixiviant solution. The pH probe was placed into the filtered lixiviant solution in a different vessel (i.e. an extraction vessel), and data logging started again. While stirring at 500 rpm, 15 g of BOF slag (in the form of <125 μm mean diameter particles) was added. The mixture was allowed to stir for one minute while the pH stabilized. The data logger was paused and the probe removed from the mixture, which was allowed to settle for about 15 minutes.

The mixture was carefully decanted into a filtration apparatus. 106 g of clear, colorless solution was collected and transferred back into the regeneration vessel. The pH probe was placed back into solution and the data logger started. With stirring at 450 rpm, 3.02 g of spent pickle liquor was added to reach the chloride equivalent of the MEA in the vessel. The mixture was allowed to stir an additional minute while the pH stabilized, after which data logging was stopped and the pH probe removed. The mixture was filtered through the same filter used in the initial lixiviant generation step, leaving a clear colorless solution containing regenerated lixiviant. The remaining slurry in the extractor was stirred at 500 rpm and the pH probe placed back in and the data logger started. The regenerated lixiviant solution was poured into the extraction vessel and the mixture stirred for several minutes while the pH stabilized. The data logger was paused and the probe removed from the mixture, which was allowed to settle for about 15 minutes.

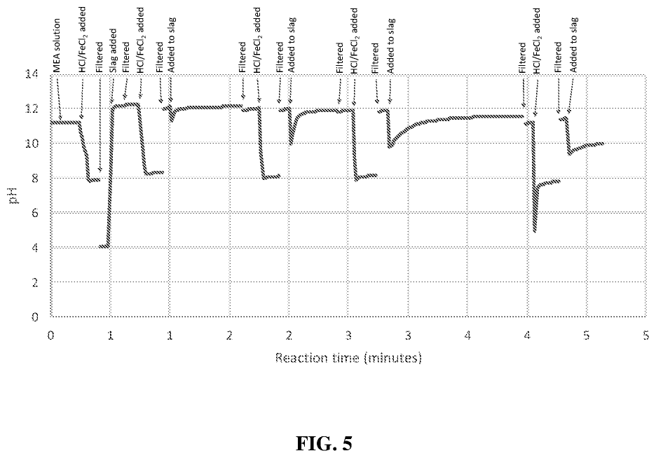

The process of decanting, filtering, regenerating, filtering, extracting was repeated 4 more times, adjusting the amount of spent pickle liquor added, based on the mass of solution recovered after the extraction step. A summary of these steps is given in Table 1. The profile of pH vs. reaction time are shown in FIG. 5.

TABLE 1

| | Mass of | Mass of | Approximate pickle |
|---|---|---|---|
| Cycle | spent pickle | solution | liquor needed for |
| # | liquor added (g) | recycled (g) | regeneration (g) |
| 1 | 4.28 | 106 | 2.93 |
| 2 | 3.02 | 101 | 2.74 |
| 3 | 2.73 | 103 | 2.75 |
| 4 | 2.73 | 95 | 2.49 |
| 5 | 2.44 | | |

After the fifth extraction the entire slurry was filtered, washed twice with about 100 ml water, then dried to a constant weight of 12.47 g. The Fe(OH)₂ collected throughout the experiment was washed twice with about 50 ml water, then dried to a constant weight of 1.60 g. It should be appreciated that the ferrous hydroxide oxidized in air, as evident by the change to a deep orange rust color.

The combined filtered solutions were evaporated to leave 6.58 g of a calcium chloride hydrate residue.

Example 6: An MgCl₂ solution was prepared by dissolving 40 g of MgCl₂.6.7H₂O in 40 g water. In a 250 ml vessel (i.e. a regeneration or precipitation vessel), 4.54 g monoethanolamine (MEA, an example of a spent lixiviant) was diluted with 80 g of water and stirred at 450 rpm. The chloride equivalent of magnesium chloride solution was determined to be 16 g for the full MEA loading. 15.2 g MgCl₂ solution was added to the stirred MEA solution, precipitating a white gel-like solid consistent with Mg(OH)₂. The mixture was allowed to stir for an additional minute. The resulting suspension was filtered, separating the magnesium hydroxide solid from the clear, colorless lixiviant solution. While stirring at 500 rpm, 10.1 g of high purity lime was added to the lixiviant solution. The mixture was allowed to stir for one minute and then allowed to settle for about 15 minutes.

The mixture was carefully decanted into a filtration apparatus. 48 g of clear, colorless solution was collected and transferred back into the regeneration vessel. While stirring at 450 rpm, 9.10 g of the MgCl₂ solution was added to reach the chloride equivalent of the MEA in the vessel. The mixture was allowed to stir an additional minute, after which it was filtered through the same filter used in the initial lixiviant generation step, leaving a clear colorless solution containing regenerated lixiviant. The remaining slurry in the extractor was stirred at 500 rpm and the regenerated lixiviant solution was poured into the extraction vessel. The mixture was stirred for several minutes, after which it was allowed to settle for about 15 minutes.

The process of decanting, filtering, regenerating, filtering, extracting was repeated 7 more times, adjusting the amount of MgCl₂ solution added based on the mass of solution recovered after the extraction step. A summary of these steps is given in Table 2.

TABLE 2

| | Mass of | | Approximate mass |
|---|---|---|---|
| | MgCl₂ | Mass of | of MgCl₂ solution |
| Cycle | solution | solution | needed for |
| # | added (g) | recycled (g) | regeneration (g) |
| 1 | 15.2 | 48 | 7.70 |
| 2 | 9.10 | 45 | 6.61 |
| 3 | 6.59 | 53 | 7.35 |
| 4 | 7.35 | 48 | 6.25 |
| 5 | 6.21 | 43 | 5.33 |
| 6 | 5.30 | 40 | 4.77 |
| 7 | 4.76 | 37 | 4.26 |
| 8 | 4.23 | | |

After the 8th extraction, the entire collection of slurry was filtered, then washed twice by re-slurrying in about 150 ml water, re-filtered, then dried to a constant weight of 6.61 g. The Mg(OH)₂ collected on a filter throughout the experiment was washed two times by re-slurrying in about 150 ml water, filtered, then dried to a constant weight of 10.41 g. Calcining the magnesium hydroxide at 600° C. yielded 5.85 g of magnesium oxide (MgO).

The combined filtered solutions were evaporated to leave 11.25 g of a calcium chloride hydrate residue.

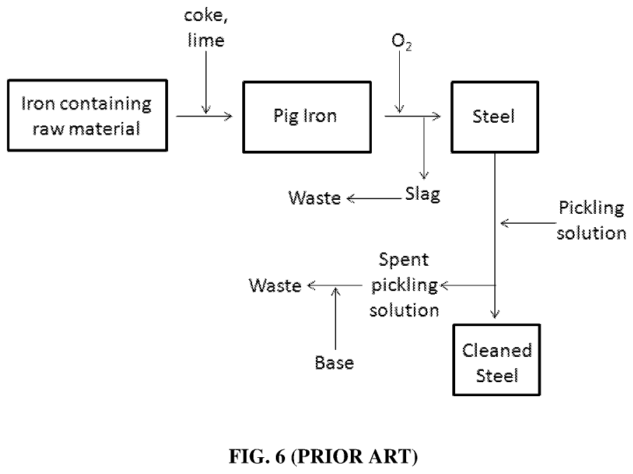

Another embodiment of the inventive concept is an integrated steel making process, where waste streams that would go to waste disposal are re-purposed to provide commercially valuable materials or to re-enter the steel making process. A typical prior art steel making process is depicted schematically in FIG. 6. As shown, an iron-containing raw material (for example, an iron ore) is heated with coke and lime to form pig iron. Pig iron is then heated in the presence of oxygen to produce steel, with waste materials collecting as a slag that is removed. Typically this slag is disposed of as a waste material. The resulting steel is later cleaned by application of a pickling solution, which is typically an acid (as described above). This provides a surface cleaned steel, and generates a spent pickling solution having considerable iron content. This spent pickling solution is typically neutralized through the addition of base and then disposed of as a waste.

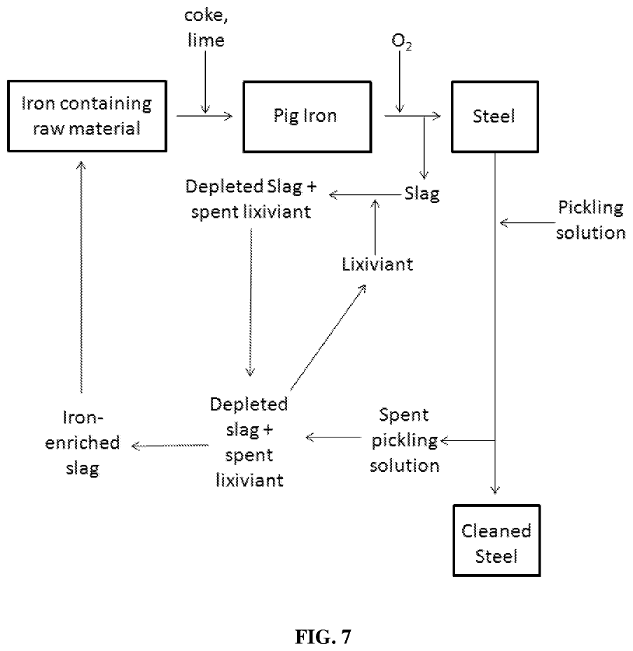

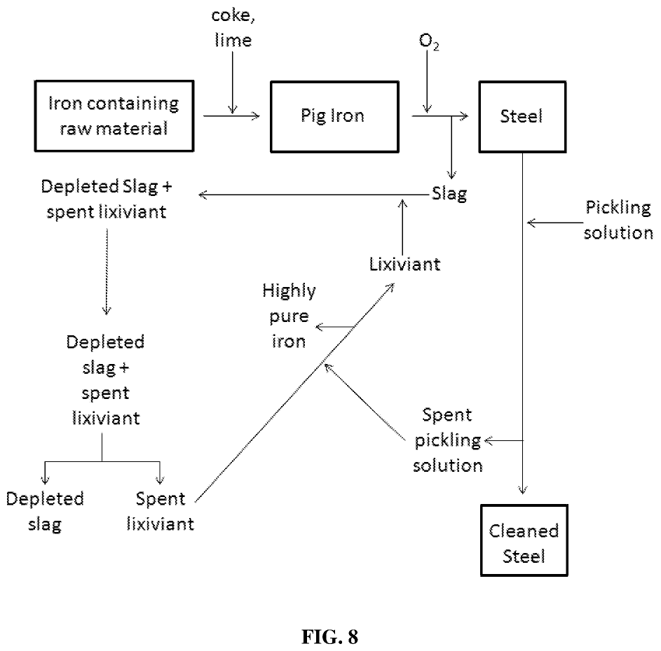

Another embodiment of the inventive concept is an integrated steel making process, examples of which are shown schematically in FIG. 7 and FIG. 8. As shown, steel slag generated by the generation of steel from an iron containing raw material is treated with a lixiviant to generate a mixture of depleted slag, spent lixiviant, and a soluble metal salt extracted from the slag by the lixiviant (for example, a calcium salt, not shown). As part of the steel production process, crude steel is treated with a pickling solution to produce a cleaned steel and a spent pickling solution. This spent pickling solution contains a soluble iron salt and can include residual acid. In some embodiments the mixture of depleted slag and spent lixiviant is treated with the spent pickling solution (as shown in FIG. 7). This results precipitation of an insoluble iron salt (forming an iron-enriched slag), and also results in regeneration of the lixiviant. This can be separated from the iron-enriched slag by any suitable method, such as settling, decantation, filtration, and/or centrifugation. The regenerated lixiviant can then be returned to the process to treat additional slag resulting from processing of iron containing raw material. Similarly, the iron-enriched slag so generated can be returned to the process as an iron containing raw material. Alternatively, such iron-enriched slag can be used in construction materials, for example as an aggregate or filler. In some embodiments the soluble metal salt can be recovered from the regenerated lixiviant (for example, by crystallization, ion exchange, precipitation, etc.). In such embodiments the lixiviant may be utilized for two or more cycles of slag extraction before the soluble metal salt is recovered.

In other embodiments, as shown in FIG. 8, the spent lixiviant can be separated from the depleted slag (for example, by settling, decanting, filtration, and/or centrifugation). The separated spent lixiviant can then be treated with spent pickling solution generated in a steel cleaning step. This both regenerates the lixiviant and generates a highly pure (e.g., greater than 80%, 85%, 90%, 95%) insoluble iron salt. This highly pure iron salt can be returned to the steel making process as an iron-containing raw material or utilized in other industrial, chemical, agricultural, and/or pharmaceutical applications. The depleted slag can be discarded, utilized as filler or aggregate in construction materials, or subjected to further treatment to recover additional commercially valuable metals. In some embodiments soluble metal salts (such as calcium salts) extracted from the slag by lixiviant treatment can be recovered from the regenerated lixiviant, for example by crystallization, ion exchange, and/or precipitation. In some embodiments the lixiviant may be utilized for two or more cycles of slag extraction before the soluble metal salt is recovered.

It should be appreciated that such processes can utilize substoichiometric (relative to the metal being recovered from the steel slag) amounts of lixiviant. In embodiments where substoichiometric amounts of lixiviant species are utilized the steel slag may need to be cycled through lixiviant-based extraction two or more times to reduce extractable metal content sufficiently to provide a stabilized filler material. It should be appreciated that small (i.e. substoichiometric relative to the amount of metal to be recovered from the steel slag) of lixiviant can be used, and that recycling in this fashion further reduces the amount of lixiviant necessary to support the process. This limits the environmental impact of lixiviant use, which can be further reduced through the use of non-volatile lixiviants, in addition to reducing or eliminating the environmental impact of spent pickle liquor treatment and/or disposal.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1-24. (canceled)

25. A method for processing a spent pickle liquor, comprising:
obtaining an industrial waste comprising CaO or Ca(OH)₂;
contacting the industrial waste with a lixiviant to solvate calcium from the industrial waste as a water soluble calcium salt, thereby generating a calcium-depleted industrial waste and a spent lixiviant; and
contacting the spent lixiviant with the spent pickle liquor, wherein the spent pickle liquor comprises a water soluble salt of a metal, to produce a suspension comprising a regenerated lixiviant and an insoluble salt of the metal.

26. The method of claim 25, further comprising the step of separating the insoluble salt of the metal from the regenerated lixiviant.

27. The method of claim 26, further comprising the step of recycling the regenerated lixiviant to contact additional industrial waste.

28. The method of claim 25, further comprising the step of recovering calcium from the water soluble calcium salt.

28. The method of claim 25, wherein the water soluble salt of the metal comprises a counterion, and wherein the counterion is selected to provide the water soluble calcium salt when paired with calcium wherein the counterion is selected from the group consisting of a halide, an organic anion, nitrite, and nitrate.

29. The method of claim 25, wherein the metal is selected from the group consisting of iron, copper, aluminum, cobalt, magnesium, barium, strontium, gold, and silver.

30. The method of claim 25, further comprising the step of combining the depleted industrial waste and the insoluble salt of the metal to generate a calcium depleted filler.

31. The method of claim 25, wherein the metal is iron, and further comprising the step of supplying the insoluble salt of the metal to a steel production process.

32. An integrated steel making process, comprising:
contacting an iron containing raw material with coke and lime, followed by heating to produce pig iron;
contacting pig iron with oxygen to produce a mixture of steel and a steel slag;
separating the mixture of steel and steel slag to provide a steel and a steel slag;
in a slag extraction process, treating the steel slag with a lixiviant selected to solubilize a metal from the steel slag to produce a mixture comprising a depleted slag, an extracted metal, and spent lixiviant;
treating the steel with a pickling solution to generate a cleaned steel and a spent pickle liquor comprising iron;
contacting the mixture with the spent pickling solution to generate an iron-enriched slag and a solution comprising regenerated lixiviant; and
returning at least a portion of the solution to the slag extraction process.

33. The method of claim 32, wherein the iron-enriched slag is returned to the integrated steel making process as a raw material.

34. The method of claim 33, further comprising the step of utilizing the iron-enriched slag in a building material.

35. The method of claim 32, wherein the extracted metal is calcium.

36. The method of claim 32, wherein the lixiviant is used in substoichiometric amounts relative to the content of the metal in the steel slag.

37. The method of claim 32, wherein the spent pickle liquor is added as a series of aliquots.

38. The method of claim 32, comprising the additional step of recovering the extracted metal from the solution.

39. An integrated steel making process, comprising:
contacting an iron containing raw material with coke and lime, followed by heating to produce pig iron;
contacting pig iron with oxygen to produce a mixture of steel and a steel slag;
separating the mixture of steel and steel slag to provide a steel and a steel slag;
in a slag extraction process, treating the steel slag with a lixiviant selected to solubilize a metal from the steel slag to produce a mixture comprising a depleted slag, an extracted metal, and spent lixiviant;
treating the steel with a pickling solution to generate a cleaned steel and a spent pickle liquor comprising iron;
separating the mixture to generate a depleted slag and a first solution comprising spent lixiviant;
contacting the first solution with the spent pickling solution to generate second solution comprising a regenerated lixiviant; and
returning at least a portion of the regenerated lixiviant to the slag extraction process.

40. The method of claim 39, wherein contacting the first solution with the spent pickle liquor generates an insoluble iron salt, and wherein the insoluble iron salt is returned to the integrated steel making process as a raw material.

41. The method of claim 39, further comprising the step of utilizing the depleted slag in a building material.

42. The method of claim 39, wherein the extracted metal is calcium.

43. The method of claim 39, wherein the lixiviant is used in substoichiometric amounts relative to the content of the metal in the steel slag.

44. The method of claim 39, further comprising the step of recovering the extracted metal from the second solution following contact with the spent pickle liquor.
